(19) United States
(12) Patent Application Publication
(10) Pub. No.: US 2025/0139947 A1
(43) Pub. Date: May 1, 2025

(54) TRAINING CUSTOMIZABLE MACHINE-LEARNING MODELS TO EFFECTIVELY PROCESS DOCUMENTS

(71) Applicant: Appian Corporation, McLean, VA (US)

(72) Inventors: Medhat GALAL, McLean, VA (US); Jacob RANK, Reston, VA (US); Matthew SHUTT, Virginia Beach, VA (US); Tom KLANCER, Alexandria, VA (US)

(73) Assignee: Appian Corporation, McLean, VA (US)

(21) Appl. No.: 18/927,383

(22) Filed: Oct. 25, 2024

Related U.S. Application Data
(60) Provisional application No. 63/593,490, filed on Oct. 26, 2023.

(51) Int. Cl. G06V 10/774; G06V 30/41

(52) U.S. Cl. CPC G06V 10/774; G06V 30/41

(57) ABSTRACT

Disclosed herein are techniques for training a customizable machine-learning model to effectively process documents. Operations may include: identifying a first document; processing, using a model, the first document; causing a display, via a user interface, of the one or more values in connection with the plurality of data fields; receiving user input; updating the model based on the user input; identifying a second document; and processing, using the updated model, the second document to identify one or more second values, in the second document, corresponding to one or more of the plurality of data fields.

### CROSS-REFERENCE TO RELATED APPLICATIONS

This application claims the benefits of priority of U.S. Provisional Patent Application No. 63/593,490 filed Oct. 26, 2023. The content of the foregoing application is incorporated herein by reference in its entirety.

### TECHNICAL FIELD

This disclosure relates to machine learning (“AI”) techniques for processing documents. More specifically, this disclosure relates to systems, methods, apparatuses and/or non-transitory computer-readable media for training a customizable machine-learning model to effectively process documents.

### BACKGROUND

Machine learning may be used to automate many aspects of business processes. For example, machine learning may be used to classify documents and emails, extract information from documents, summarize or create content as part of a business process, confirm the results of data extracted from a document, detect text language and translate a document into a different language, among other applications. These applications of machine learning may provide more efficient ways to complete complex, manual tasks that a human would otherwise have to complete.

However, integrating machine learning into a business process can be complicated and time-consuming. For example, a machine learning model may involve development of an algorithm capable of handling one or more specific tasks. After the machine learning model is created, it may be trained in order to properly complete the tasks it is designed to handle. This may involve additional testing and iterations of the algorithm before the machine learning model may be deployed as part of a business process. This development and training of a machine learning model may involve extensive time and skills. Further iterations on a model used in a business process may introduce complications and require additional time and expertise. Traditional methods of training models or using off-the-shelf models to perform business tasks require more complexity in incorporating the model into a business process, more training material for the model to reach appropriate levels of accuracy, and more time and expense to put the model into operation. Traditional methods that use public or third party machine learning models can also introduce security and data risks through interacting with models which are not properly integrated into a business process.

In view of these limitations in developing customized machine learning models, there are needs for technological solutions to create customized, trained machine learning models for use in a business process. Such technological solutions should provide a low-code platform that facilitates the building, configuration, and training of custom machine learning models. Such solutions should allow a user to create machine learning models with minimal-to-no coding using drag-and-drop features and other graphical tools to automate the development of the machine learning model. Such low-code platforms should enable faster and easier delivery of machine learning models that may be customized to a specific business process application. Such low-code platforms should further enable users to automate the process of iterating or training a machine learning model as part of the business process itself.

### SUMMARY

Certain embodiments of the present disclosure relate to a non-transitory computer-readable medium, including instructions that when executed by at least one processor, cause the at least one processor to perform operations for training a customizable machine-learning model to effectively process documents. The operations may comprise: identifying a first document, processing, using a model, the first document to identify one or more values in the first document corresponding to one or more of a plurality of data fields associated with the first document, causing a display, via a user interface, of the one or more values in connection with the plurality of data fields, receiving user input, wherein the user input indicates one or more of: a confirmation of the one or more values, a correction of the one or more values, a correction of the one or more of the plurality of data fields, or an addition of a new value for a data field of the plurality of data fields, updating the model based on the user input, identifying a second document, and processing, using the updated model, the second document to identify one or more second values in the second document corresponding to one or more of the plurality of data fields.

According to a disclosed embodiment, the model may comprise a pre-trained machine-learning model with an overlaid mapping layer.

According to a disclosed embodiment, the model may comprise a trainable machine-learning model configured to be retrained in production.

According to a disclosed embodiment, updating the model based on the user input may comprise training the machine-learning model based on the user input.

According to a disclosed embodiment, the operations may further comprise, based on the user input, generating output data for the first document, wherein the output data includes values, determined by the model to map to one or more of the plurality of data fields, that are confirmed by a user.

According to a disclosed embodiment, the operations may further comprise associating the model with a database for storing user-confirmed output data for a plurality of documents processed based on the model.

According to a disclosed embodiment, the first document and the second document may be of a same type.

According to a disclosed embodiment, the first document and the second document may be of a different type.

According to a disclosed embodiment, the model may be customized to process a particular type of document for an enterprise organization.

According to a disclosed embodiment, the operations may further comprise receiving names of the plurality of data fields and data types of the plurality of data fields, and training the model based on the names and the data types.

According to a disclosed embodiment, the operations may further comprise causing a display of a user interface configured to allow a user to enter the names of the plurality of data fields and the data types of the plurality of data fields, wherein the names and the data types are customized for a particular type of document associated with the user.

Certain embodiments of the present disclosure may relate to a non-transitory computer-readable medium, including instructions that when executed by at least one processor, cause the at least one processor to perform operations for training a customizable machine-learning model to effectively process documents. The operations may comprise: identifying names of a plurality of data fields associated with one or more types of documents, identifying data types of the plurality of data fields, configuring, based on the names and the data types, a model for identifying values corresponding to the plurality of data fields in documents of the one or more types, receiving a document of the one or more types, processing, using the model, the document to identify one or more values in the document corresponding to one or more of the plurality of data fields, causing a display, via a user interface, of the one or more values in connection with the plurality of data fields, receiving user input, wherein the user input indicates one or more of: a confirmation of the one or more values, a correction of the one or more values, a correction of the one or more of the plurality of data fields, or an addition of a new value for a data field of the plurality of data fields, and updating the model based on the user input.

According to a disclosed embodiment, the model may comprise a machine-learning model.

According to a disclosed embodiment, configuring the model based on the names and the data types may comprise training the machine-learning model based on the names and the data types, and updating the model based on the user input may comprise training the machine-learning model based on the user input.

According to a disclosed embodiment, the operations may further comprise based on the user input, generating output data for the document, wherein the output data includes values determined by the model to map to one or more of the plurality of data fields that may be confirmed by a user.

According to a disclosed embodiment, the document may be a first document, and the operations may further comprise receiving a second document of the one or more types, wherein the second document may be of the same type as the first document, and processing, using the updated model, the second document to identify one or more second values corresponding to one or more of the plurality of data fields.

According to a disclosed embodiment, the operations may further comprise causing a display of a user interface configured to allow a user to enter the names of the plurality of data fields and the data types of the plurality of data fields, wherein the names and the data types may be customized for a particular type of document associated with the user.

According to a disclosed embodiment, the operations may further comprise receiving an indication of a plurality of sections of a document of the one or more types, wherein the indication may indicate that a first subset of the plurality of data fields are included in a first section of the plurality of sections and that a second subset of the plurality of data fields are included in a second section of the plurality of sections.

According to a disclosed embodiment, the operations may further comprise configuring the model based on the indication of the plurality of sections.

According to a disclosed embodiment, the names of the plurality of data fields may comprise a first identifier for a first data field of the plurality of data fields, and updating the model based on the user input may comprise determining, based on the user input, a second identifier for the first data field.

According to a disclosed embodiment, each of the first identifier and the second identifier may be used as a key for identifying a value in a key-value pair in a document of the one or more types.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate several embodiments and, together with the description, serve to explain the disclosed principles.

FIG. 1 is a block diagram of an exemplary system for training customizable machine-learning models, according to embodiments of the present disclosure.

FIG. 2 is a block diagram of an exemplary computing device for training customizable machine-learning models, according to embodiments of the present disclosure.

FIG. 3 is a context diagram of an exemplary system for training customizable machine-learning models, according to embodiments of the present disclosure.

FIG. 4 is a container diagram of an exemplary system for training customizable machine-learning models, according to embodiments of the present disclosure.

FIG. 5 is a block diagram of an exemplary process for providing document processing using a customized machine learning model, according to embodiments of the present disclosure.

FIG. 6 is a block diagram of an exemplary process for using a customized machine-learning model for email triage, according to embodiments of the present disclosure.

FIG. 7 is a flowchart of an exemplary process for training a customizable machine-learning model to effectively process documents, according to embodiments of the present disclosure.

FIG. 8 is a flowchart of an exemplary process for training a customizable machine-learning model to effectively process documents, according to embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently. Reference will now be made in detail to the disclosed embodiments, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for training a customizable machine learning model to effectively process documents described herein overcome several technological problems relating to the efficiency and functionality of machine learning models. In particular, the disclosed embodiments provide low-code techniques for developing and training customized machine learning models for integration with business processes. As discussed above, it may be time and cost ineffective to develop and train customized machine learning models for use within specific business processes. The disclosed embodiments provide technical solutions to these and other problems arising from current techniques. For example, various disclosed embodiments create efficiencies over current techniques by providing a low-code platform for developing and training machine learning models that can be used in various business processes.

Reference will now be made in detail to the disclosed embodiments, examples of which are illustrated in the accompanying drawings.

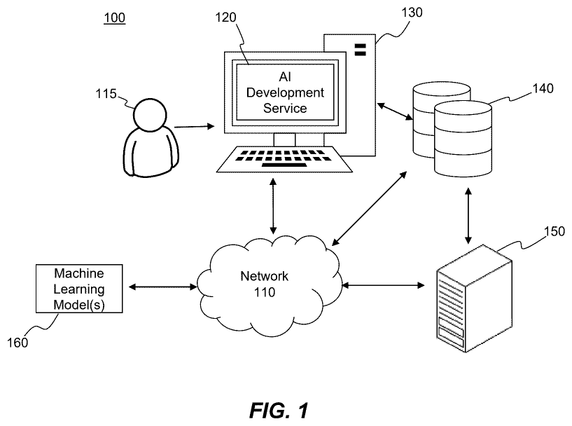

FIG. 1 depicts an exemplary system 100 for training a customizable machine-learning model to effectively process documents, consistent with the disclosed embodiments. System 100 may represent an environment in which software code is developed and/or executed, for example in a cloud computing environment. System 100 may include one or more AI development services 120, one or more computing devices 130, one or more databases 140, one or more servers 150, and one or more machine learning models 160, as shown in FIG. 1. User 115 may engage with system 100 through computing device 130.

The various components may communicate over a network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

Computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s) 140 for storing data. Database 140 may be accessed by computing device 130, server 150, or other components of system 100 for downloading, receiving, processing, editing, or running stored software or code. Database 140 may be any suitable combination of data storage devices, which may optionally include any type or combination of databases, load balancers, dummy servers, firewalls, back-up databases, and/or any other desired database components. For example, database 140 may include object databases, relational databases, graph databases, hierarchical databases, cloud databases, NoSQL databases, document databases, distributed databases, network databases, and/or any other suitable type of database. Additionally or alternatively, database 140 may use or be based on suitable types of data structures, such as trees, arrays, queues, linked lists, stacks, graphs, hash tables, and/or other types of data structures. In some embodiments, database 140 may be employed as a cloud service, such as a Software as a Service (SaaS) system, a Platform as a Service (PaaS), or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. Data sharing platform 140 may include other commercial file sharing services, such as Dropbox™, Google Docs™, or iCloud™. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

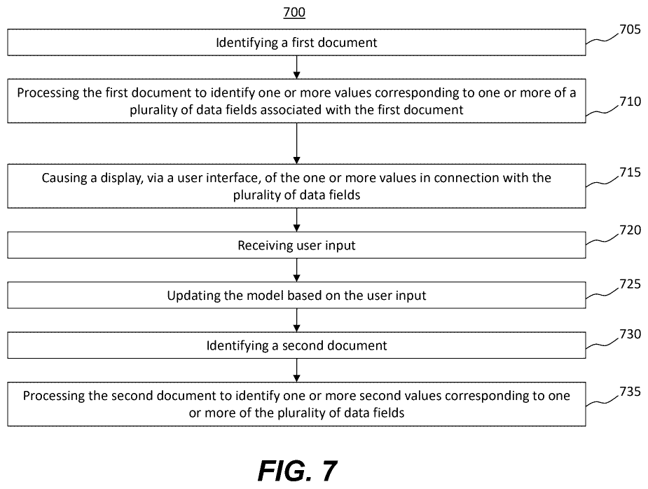

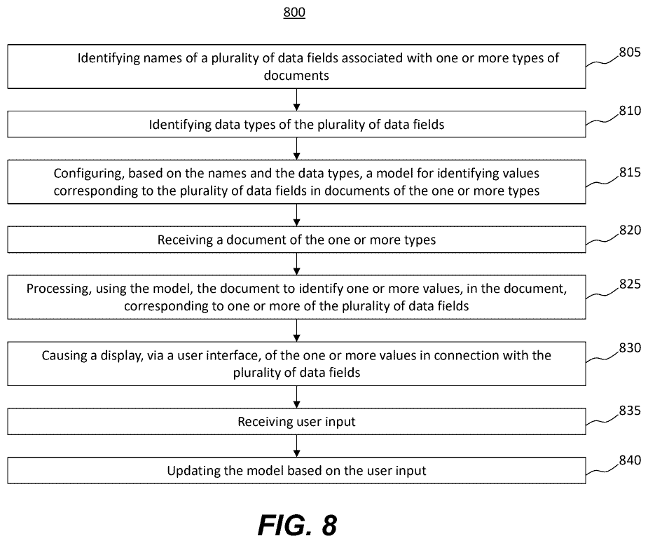

System 100 may also comprise one or more server device(s) 150 in communication with network 110. Server device 150 may manage the various components in system 100. In some embodiments, server device 150 may be configured to process and manage requests between computing devices 130 and/or databases 140. In embodiments where software code is developed within system 100, server device 150 may manage various stages of the development process, for example, by managing communications between computing devices 130 and databases 140 over network 110. Server device 150 may identify updates to code in database 140, may receive updates when new or revised code is entered in database 140, and may participate in training a customizable machine learning model to effectively process documents as discussed below in connection with FIGS. 7-8.

System 100 may also comprise one or more artificial intelligence (“AI”) development services 120 in communication with network 110. AI development service 120 may be any device, component, program, script, or the like, for training a customizable machine learning model to effectively process documents within system 100, as described in more detail below. AI development service 120 may be configured to monitor other components within system 100, including computing device 130, database 140, and server 150. In some embodiments, AI development service 120 may be implemented as a separate component within system 100, capable of analyzing software and computer codes or scripts within network 110. In other embodiments, AI development service 120 may be a program or script and may be executed by another component of system 100 (e.g., integrated into computing device 130, database 140, or server 150). AI development service 120 may further comprise one or more components (e.g., scripts, programs, etc.) for performing various operations of the disclosed embodiments. For example, AI development service 120 may be configured to identify a first document and process the first document using a model to identify one or more values corresponding to a plurality of data fields. AI development service 120 may also be configured to cause a display of the one or more values via a user interface. AI development service 120 may further by configured to receive user input and update the model based on the user input. AI development service 120 may then identify a second document and process the second document using the updated model to identify one or more second values corresponding to the plurality of data fields.

System 100 may further comprise at least one machine learning model 160. Machine learning model 160 may be any system, device, component, program, script, or the like, for processing documents. For example, in some embodiments, machine learning model 160 may comprise a large language model such as Amazon Bedrock™, GPT™, LLaMA™, Gemini™, Claude™, or any other type of model or operation associated with a natural language. Machine learning model 160 may be in any desired form, such as a statistical model (e.g., a word n-gram language model, an exponential language model, or a skip-gram language model) or a neural model (e.g., a recurrent neural network-based language model or an LLM). In some examples, machine learning model 160 may include an LLM with artificial neural networks, transformers, and/or other desired machine learning architectures. In some embodiments, machine learning model 160 may include a trained language model. Machine learning model 160 may be trained using, for example, supervised learning, self-supervised learning, semi-supervised learning, unsupervised learning, and/or reinforcement learning. In some examples, machine learning model 160 may be pre-trained to generally understand a natural language, and the pre-trained language model may be fine-tuned for software development. For example, the pre-trained language model may be fine-tuned for software generation tasks based on training data of descriptions associated with software generation tasks, and the fine-tuned language model may be used to receive and process the identified software generation task. In some examples, machine learning model 160 may include generative pre-trained transformers (GPT) or other types of generative machine learning configured to generate human-like content. In some examples, the machine learning model 160 may comprise a pre-trained model combined with a retrainable mapping layer to coordinate between the pre-trained model and business documents and data.

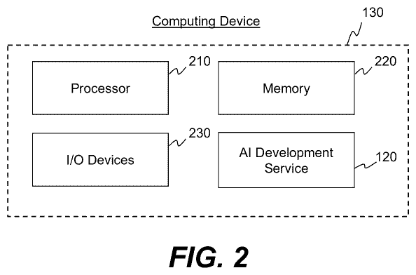

FIG. 2 is a block diagram showing a computing device 130 including AI development service 120 in accordance with disclosed embodiments. Computing device 130 may include a processor (or processors) 210. Processor (or processors) 210 may include one or more data or software processing devices. For example, processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be based on the ARM architecture, a mobile processor, or a graphics processing unit, etc. In some embodiments, AI development service 120 may be employed as a cloud service, such as a Software as a Service (SaaS) system, a Platform as a Service (PaaS), or Infrastructure as a Service (IaaS) system. For example, prompt generator 120 may be based on infrastructure or services of Amazon Web Services™ (AWS™), Microsoft Azure™, Google Cloud Platform™, Cisco Metapod™, Joyent™, vmWare™, or other cloud computing providers. The disclosed embodiments are not limited to any type of processor configured in the computing device 130.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to train a customizable machine learning model from computing device 130, for example, using process 700 or process 800, described in detail below. The disclosed embodiments are not limited to particular software programs or devices configured to perform dedicated tasks. For example, memory 220 may store a single program, such as a user-level application, that performs the functions of the disclosed embodiments or may comprise multiple software programs. Additionally, processor 210 may in some embodiments execute one or more programs (or portions thereof) remotely located from the computing device 130. Furthermore, memory 220 may include one or more storage devices configured to store data (e.g., machine learning data, training data, algorithms, etc.) for use by the programs, as discussed further below.

Computing device 130 may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through network 110. For example, prompt generator 120 may use a network adaptor to scan for code and code segments within system 100. In some embodiments, the I/O devices 230 may also comprise a touchscreen configured to allow a user to interact with prompt generator 120 and/or an associated computing device. The I/O device 230 may comprise a keyboard, mouse, trackball, touch pad, stylus, and the like.

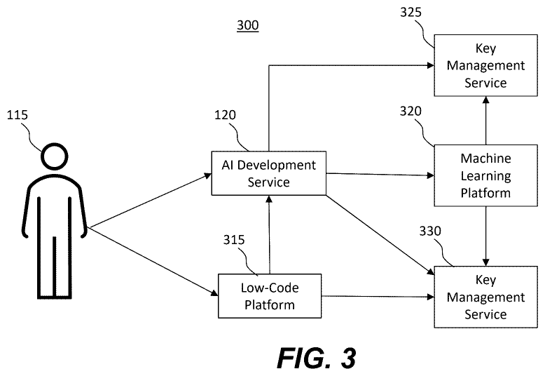

FIG. 3 is a context diagram of an exemplary system 300 for training customizable machine learning models, according to embodiments of the present disclosure. User 115 may comprise a low-code developer. For example, user 115 may need to train, deploy, and evaluate machine learning models and may have limited or no data science or coding knowledge. User 115 may configure a workflow using low-code platform 315 that may use a machine learning model to automate a business process. A workflow may comprise independent processes and tasks designed to achieve a specific outcome for a business. Low-code platform 315 may orchestrate one or more workflows. Such workflows may call AI development service 120 and may act as an entry point to a user interface associated with AI development service 120. For example, low-code platform 315 may allow user 115 to develop an overall workflow process for achieving a business goal or result and such workflow process may incorporate a machine learning model using AI development service 120. Low code platform 315 may comprise a tenant in AI development service 120. For example, low code platform 315 may share common access to and privileges within AI development service 120. Low code platform 315 may call AI development service 120 and may authenticate with AI development service 120 as a tenant.

AI development service 120 may manage a CRUD application. A CRUD application may consist of four operations: create, read, update, and delete. The CRUD application may include three parts: a database, a user interface, and application programming interfaces (API's). AI development service 120 may also manage user interface renderings associated with displaying user interfaces associated with system 300. For example, as disclosed below with respect to process 700 and 800, graphical user interfaces may be rendered to allow user input during training and customization of machine learning models. AI development service 120 may manage the rendering of the graphical user interfaces that may allow users, such as user 115, to provide input regarding the training of a machine learning model. AI development service 120 may also manage user permissions for users interacting with system 300. For example, when users provide input related to the training and customization of a machine learning model, the user may be required to provide authentication credentials. AI development service 120 may manage user permissions by determining whether user authentication credentials meet an access policy for training machine learning models. In some embodiments, user 115 may interact directly with AI development service 120 through a user interface displayed on a computing device, such as computing device 130. In other embodiments, user 115 may configure workflows through low-code platform 315 and the workflows may call to AI development service 120 as a tenant.

Low-code platform 315 may also store a public key in key management service 330. Key management service 330 may be a system for securely generating, storing, managing, and backing up cryptographic keys. For example, key management service 330 may manage secrets such as SSL certificate private keys, SSH key pairs, API keys, code signing private keys, document signing private keys, database encryption keys, or any other cryptographic key type. Key management service 330 may manage identities of tenants associated with low-code platform 315 in a multitenant k8s micro service. When low code platform 315 calls to AI development service 120 as a tenant, low code platform 315 may sign a JSON web token (“JWT”) with a private key of an asymmetric key pair. AI development service 120 may retrieve the public key associated with the private key sent by low code platform 315 from key management service 330. AI development service 120 may validate the JWT signature from low code platform 315 based on the retrieved public key to verify the identification and authentication of low code platform 315.

AI development service 120 may delegate all machine learning logic to machine learning platform 320. Machine learning platform 320 may manage all machine learning tasks. For example, machine learning platform 320 may orchestrate inference and training of machine learning models, such as machine learning model 160 as disclosed herein with respect to FIG. 1. When delegating a machine learning task to machine learning platform 320, AI development service 120 may sign a request with a private key of an asymmetric key pair. Key management service 325 may generate, store, and manage cryptographic keys. For example, key management service 325 may manage cryptographic keys used for authentication between k8s microservices. Key management service 325 may store a public key of an asymmetric key pair associated with AI development service 120. Machine learning platform 320 may verify requests received from AI development service 120 by retrieving a public key associated with the private key of AI development service 120 from key management service 325.

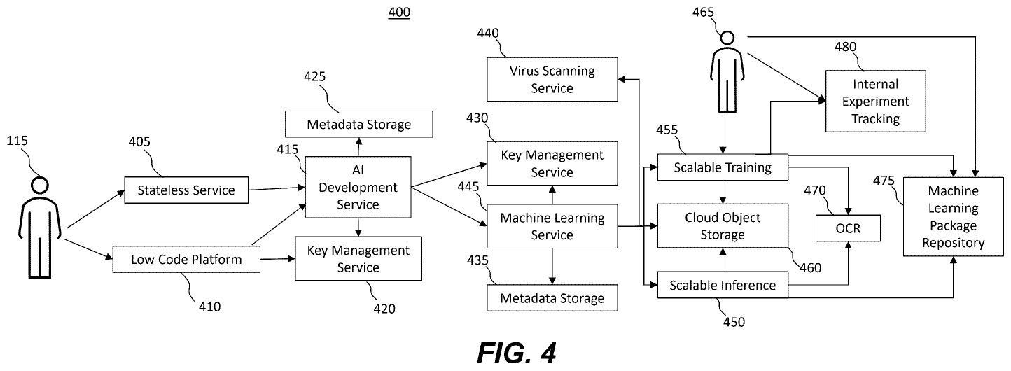

FIG. 4 depicts a container diagram of an exemplary system 400 for training customizable machine-learning models. User 115 may comprise a low-code developer. For example, user 115 may need to train, deploy, and evaluate machine learning models and may have limited or no data science or coding knowledge. User 115 may configure the training of customizable machine learning models through stateless service 405. Stateless service 405 may allow user 115 to build a graphical user interface through low-code development methods. For example, stateless service 405 may allow user 115 to build a graphical user interface by dragging and dropping interface elements into a visual workspace that may be configured to operate as a functional graphical user interface. Stateless service 405 may evaluate and serve the graphical user interface operated by user 115.

User 115 may call services through low code platform 410. Low code platform 410 may correspond to low code platform 315 as disclosed herein with respect to FIG. 3. Low code platform 410 may be the primary environment for low code development by user 115. All requests for machine learning tasks may originate from low code platform 410. Low code platform 410 may be accessed by user 115 through a graphical user interface. For example, user 115 may access low code platform 410 for low code development through a graphical user interface through I/O devices 230 of computing device 130.

Low code platform 410 may register a public key with key management service 420. Key management service 420 may correspond to key management service 330, as disclosed herein with respect to FIG. 3. Key management service 420 may manage public keys for all low-code platform instances that may need to authenticate with AI development service 415. For example, low code platform 410 may register a public key with key management service 420 that corresponds to a private key in an asymmetric key pair. Low code platform 410 may designate all machine learning logic to AI development service 415. When designating machine learning logic to AI development service 415, low code platform 410 may transmit the private key of the asymmetric key pair with the request to AI development service 415. AI development service 415 may retrieve the public key associated with low code platform 410 from key management service 420 to authenticate the private key received in the request received from low code platform 410.

AI development service 415 may correspond to AI development service 120 as disclosed herein with respect to FIG. 1. In some embodiments, AI development service 120 may manage one or more machine learning design object data. Design objects may provide specific pieces of functionality to an application and design objects may be grouped in an application based on common purposes. Design objects may function together to meet one or several use cases. For example, in some embodiments, design object data may include rule-based objects that may be used in expressions to reference specific values or perform complex operations and queries related to machine learning training and customization. AI development service 120 may specifically manage design object data related to machine learning. For example, a machine learning design object managed by AI development service 120 may be used to create, train, and deploy machine learning models within a larger application. AI development service 120 may further create the API's that may be called by stateless service 405 or low code platform 410. AI development service 120 may store design object data in metadata storage 425. Metadata storage 425 may store design object metadata in a secure and scalable manner.

AI development service 415 may transmit all machine learning requests received from low code platform 410 or stateless service 405 to machine learning service 445. Machine learning service 445 may provide an API to AI development service 415 for machine learning model training, evaluation, and prediction. AI development service 415 may sign requests sent to machine learning service 445 with a private key associated with AI development service 415. Key management service 430 may manage keys that may be used between standalone services within system 400, such as low code platform 410, AI development service 415, and machine learning service 445. Key management service 430 may further encrypt and/or decrypt customer data using encryption keys associated with each tenant of system 400. For example, AI development service 415 may send a request for a machine learning task to machine learning service 445. The request may include a private key associated with AI development service 415. Machine learning service 445 may authenticate the request received from AI development service 415 by matching the private key from the request with the associated public key that may be stored in key management service 430. Machine learning service 445 may further encrypt persisted customer data through key management service 430. Machine learning service 445 may store training datasets, training metadata, and inference metadata in metadata storage 435. The training and inference metadata stored in metadata storage 435 may not require per-tenant encryption through key management service 430.

Machine learning service 445 may transmit files associated with machine learning tasks to virus scanning service 440. For example, machine learning service 445 may receive a plurality of documents, emails, or files with a request to extract and process data found in the documents, emails, or files. Virus scanning service 440 may include a software component that may detect and remove malicious software from a computer or file. Virus scanning service 440 may provide streaming anti-virus scanning to files within system 400.

Machine learning service 445 may call scalable training system 455 and scalable inference system 450. Machine learning service 445 may further store training and inference inputs in and retrieve outputs from cloud object storage 460. Scalable training system 455 may produce trained machine learning models and performance metrics when given a set of configurations and requirements for the trained machine learning model. Accordingly, if machine learning service 445 requests the generation of a trained machine learning model, machine learning service 445 may call scalable training system 455 to produce a customized trained model based on a set of configuration data. Scalable training system 455 may train customized machine learning models to process documents associated with an enterprise organization. For example, an organization may have one or more specific types of documents that a machine learning model may be trained to extract and process data from. In some embodiments, scalable training service 455 may train machine learning models using, for example, supervised learning, self-supervised learning, semi-supervised learning, unsupervised learning, and/or reinforcement learning.

A second user 465 may include a machine learning algorithm developer. While user 115 may be a low-code developer with limited or no knowledge of code development, second user 465 may have more knowledge of machine learning algorithms. Second user 465 may develop and evaluate the efficacy of machine learning algorithms that may be produced and trained by scalable training system 455. Second user 465 may develop machine learning logic and run scalable training system 455 to develop and evaluate the efficacy of the developed machine learning logic. When second user 465 runs a machine learning algorithm through scalable training system 455, scalable training system 455 may store engineering results related to the algorithm in internal experiment tracking 480. Internal experiment tracking 480 may provide API's for storing and retrieving internal experiment results. For example, second user 465 may retrieve and view results of various machine learning algorithms run through scalable training system 455 by accessing internal experiment tracking 480. The results displayed through internal experiment tracking 480 may allow second user 465 to evaluate the efficacy of various machine learning algorithms. After second user 465 has developed a machine learning algorithm, second user 465 may publish a completed production package corresponding to the machine learning algorithm to machine learning package repository 475.

Scalable inference system 450 may run a pre-trained model for prediction. Accordingly, if machine learning service 455 transmits an input related to a pre-trained machine learning model, then machine learning service 455 may call scalable inference system 450 to run a trained machine learning model for prediction based on a user input. Both scalable training system 455 and scalable inference system 450 may retrieve inputs from and store outputs in cloud object storage 460. Cloud object storage 460 may store both training artifacts and ephemeral data that may be needed to communicate with scalable training system 455 and scalable inference system 450.

In some embodiments, scalable training system 455 and scalable inference system 450 may call OCR 470. OCR 470 may provide optical character recognition of a document to recognize text in the document. In some embodiments, where text recognition of a document is not needed, scalable training system 455 and scalable inference system 450 may not call OCR 470.

In some embodiments scalable training system 455 and scalable inference system 450 may retrieve code from machine learning package repository 475. Machine learning package repository 475 may store machine learning packages. Each machine learning package may define training and inference logic to solve specific machine learning problems. For example, after second user 465 has developed, tested, and evaluated a machine learning algorithm, second user 465 may publish a finalized machine learning production package to machine learning package repository 475. Machine learning package repository 475 may provide the code and logic to support customizable machine learning models.

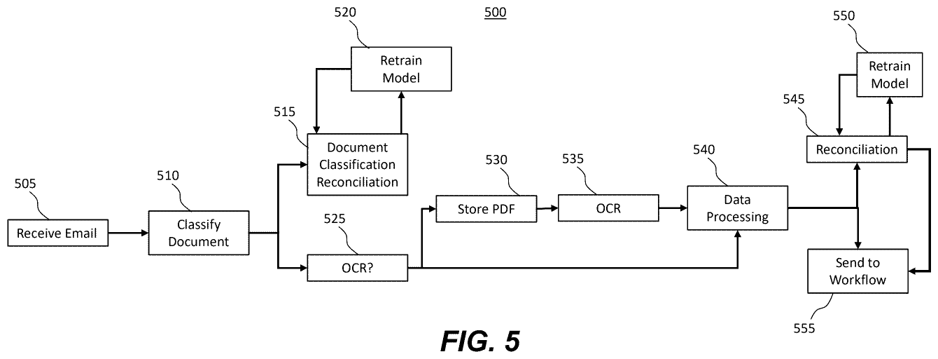

FIG. 5 depicts process 500 for training a customizable machine learning model to reconcile documents. At step 505 of process 500, an email may be received. In some embodiments, the email may contain an attachment (e.g., PDF file, PNG file, JPEG file, Word file, etc.). The attachment to the email may comprise, for example, an invoice, a paystub, a W2, or any other forms or documents. The attachment may be extracted from the email.

After extracting the document from the received email, step 510 of process 500 may include classifying the document. In some embodiments, classifying the document may include recognizing text in the document and tagging specific content in the document. Documents may be classified using, for example, Cloud Vision API. The documents may be classified using a trained machine learning model. For example, a machine learning model may be trained to extract documents from an email and classify the type of document attached to the email. For example, the document may be classified based on document type, such as pay stub, invoice, W2, an order form, or any other type of document. When classifying the document, a confidence threshold may be calculated. For example, a confidence threshold may include a score, a ranking, a percentage, or any other form of scoring metric. The confidence threshold may be calculated based on the likelihood that the document was classified as the correct document type.

In some embodiments, if the confidence threshold is less than a predetermined amount, then process 500 may proceed to step 515. For example, if the confidence threshold is less than 80%, then process 500 may proceed to step 515. Step 515 of process 500 may include document classification reconciliation. Step 515 of process 500 may include manually reviewing a document received in an email to confirm the classification made in step 510 of process 500. In some embodiments, if the machine learning model properly classified the document, then the document classification may be confirmed. If the machine learning model did not properly classify the document, then the document may be manually reclassified with the correct classification. After confirming or correcting the classification, process 500 may proceed to step 520. Step 520 of process 500 may include retraining the machine learning model used to classify documents. For example, the document and the classification type may be used as training data to retrain the machine learning model used in step 510 of process 500 to classify documents.

If the confidence threshold is above a predetermined amount, then process 500 may proceed directly to step 525. For example, if the confidence threshold is more than 80%, then process 500 may proceed directly to step 525 without completing step 515 or 520. At step 525, it may be determined whether the document that was extracted from the email should undergo optical character recognition (OCR). OCR may convert documents from images into a machine-readable format. For example, OCR may be used to convert scanned documents and images into electronic versions with editable and searchable text. A document may be converted using OCR if the document is an image file (e.g., PNG, JPEG, etc.) or a PDF file. A document may not be converted using OCR if the document is a Word document or is in another machine-readable format.

If it is determined that the document should be converted using OCR, then process 500 may proceed to step 530. At step 530 of process 500, the document may be stored. For example, in some embodiments, the document may be stored in cloud storage, in a local file system, or any other document storage system. At step 535 of process 500, the stored document may be converted to a machine-readable format using OCR. For example, in some embodiments, the document may be converted into a machine-readable format using AWS Textract, Finereader, Document Understanding, or any other OCR system.

After a document has been converted using OCR, process 500 may proceed to step 540. In other embodiments, if it is determined at step 525 of process 500 that a document does not need to be converted, then process 500 may proceed directly from step 525 to step 540. Step 540 of process 500 may include data processing. In some embodiments, data processing may include extracting data from the document and inputting the extracted data into another system, component, or interface. For example, pricing information may be extracted from a customer invoice and input into a billing system. In other embodiments, data processing may include determining if all required data is included in a document. As an example, data processing may include determining that signatures or other values are missing from a product or service order. Data processing may be completed by a machine learning model trained to recognize specific data fields in a document, extract the data fields, and input the data fields into another system.

In some embodiments, step 540 of process 500 may further include calculating a confidence threshold associated with the extraction of data from the document. For example, a confidence threshold may include a score, a ranking, a percentage, or any other form of scoring metric. The confidence threshold may be calculated based on the likelihood that the data was properly extracted and processed. In some embodiments, if the confidence threshold is below a predetermined threshold, then the document may be transmitted to step 545 of process 500. At step 545 of process 500, the document may be manually reviewed to confirm or update the processed data. If the processed data was correctly extracted and input correctly into the appropriate system, then the manual reviewer may not need to update the data. If the processed data was incorrectly extracted or incorrectly input into the appropriate system, then the manual reviewer may update the data inputs. At step 550 of process 500, the machine learning model used in step 540 of process 500 may be retrained. Retraining the machine learning model may comprise using the processed data and document as sample training data for the machine learning model.

If the confidence threshold associated with the extraction of data from the document is above a predetermined threshold, then process 500 may proceed directly to step 555. Step 555 of process 500 may include sending the processed data to a workflow for continued processing. For example, the processed data may be sent to a web integration, a SQL database, a robotic process automation, or any other workflow process for additional processing.

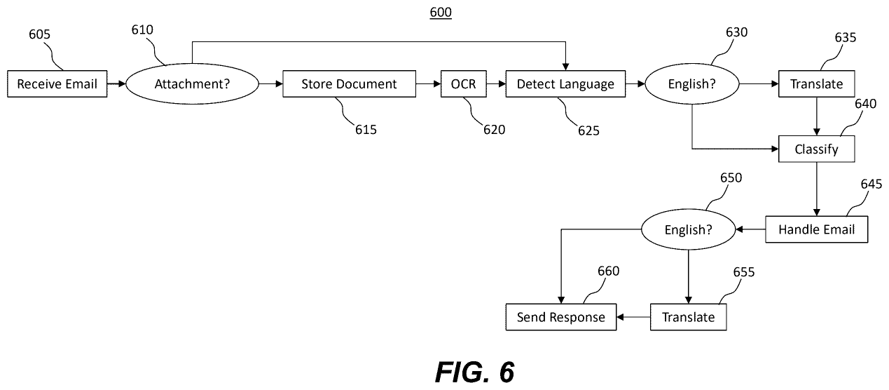

FIG. 6 depicts process 600 for using a trained machine learning model to intelligently triage emails. Organizations may receive hundreds or even thousands (or more) of emails each day. It may be a time-consuming and inefficient process to manually review received emails and route the emails to the appropriate contact point within the organization. Accordingly, process 600 may automate the process of classifying emails and responding to emails. At step 605 of process 600, an email may be received. In some embodiments, the email may contain an attachment (PDF file, PNG file, JPEG file, Word file, etc.). The attachment to the email may comprise, for example, an invoice, a paystub, a W2, or any other forms or documents. In some embodiments, the email may not contain any attachments. At step 610 of process 600, it may be determined whether or not the email contains an attachment.

If the email contains an attachment, process 600 may proceed to step 615. At step 615 of process 600, the attached document may be stored. In some embodiments, the document may be stored in cloud storage, in a local file system, or any other document storage system. At step 620 of process 600, the store document may be converted to a machine-readable format using OCR. For example, in some embodiments, the document may be converted using AWS Textract, Finereader, Document Understanding, or any other OCR system.

If process 600 determines that the email received in step 605 does not contain an attachment, then process 600 may proceed directly to step 625. At step 625 of process 600, the language of the email and/or the attachment may be detected. The language of the email and/or the attached document may be detected by a pre-trained machine learning model. For example, a machine learning model may be trained to recognize text in an email or document and determine the language in which the email or document is written. At step 630 of process 600, the machine learning model may determine if the email and/or document are written in English. If the pre-trained machine learning model determines that the email and/or document are written in a language other than English, then process 600 may proceed to step 635. At step 635 of process 600, the email and/or document may be translated into English. The document may be translated to English using a pre-trained machine learning model that is trained to convert the language of documents.

If the email and/or document are determined to be written in English, then process 600 may proceed directly to step 640. Step 640 of process 600 may include classifying the email and/or document. For example, the email and/or document may be related to a customer complaint, a customer invoice, a payment receipt, a contract, a purchase order, a customer question, or any other type of email and/or document. Classifying the email and/or document may allow the email and/or document to be directed to the proper individual or further automated steps in a process. For example, if the email is classified as a customer complaint, then the email may be transmitted to a customer service representative. If the email is classified as a new purchase order, then the email may be transmitted to a sales representative. At step 645 of process 600, the person to whom the email was directed based on the classification may respond, docket, process, or otherwise handle the email. In some embodiments, step 645 may include an individual manually responding to or handling the email. In other embodiments, step 645 may include an automated system that may process the email and the response.

At step 650 of process 600, it may be confirmed whether the original email was received in English or in another language. If the original email was received in a language other than English, then step 600 may proceed to step 655. At step 655, the response to the email that may be written by an individual or processed using an automated system may be translated to the language of the original email. For example, at step 645 of process 600, the individual or automated process may process the email and provide a response in English. At step 655 of process 600, the English response may be translated automatically into the language of the original email. If the language of the original email was English, then process 600 may skip step 655. At step 660 of process 600, the response may be sent to the original recipient.

FIG. 7 depicts a flowchart of a process 700 for training a customizable machine learning model to effectively process documents. Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

Step 705 of process 700 may include identifying a first document. In some embodiments, the first document may be received as an attachment to an email. In other embodiments, the first document may be received through a web application, an online portal, an instant messaging service, or by any other means of electronically transmitting a document. In some embodiments, the document may include an invoice, a receipt, a form, a contract, an agreement, a bank statement, a financial report, or any other form of document.

Step 710 of process 700 may include processing, using a model, the first document to identify one or more values, in the first document, corresponding to one or more of a plurality of data fields associated with the first document. In some embodiments, the model may comprise a pre-trained machine learning model. For example, the model may correspond to machine learning model 160, as disclosed herein with respect to FIG. 1. The model may be customized to process a particular type of document for an enterprise organization. For example, the model may be customized to process one or more document types, such as an invoice, a receipt, a form, a contract, an agreement, a bank statement, a financial report, or any other form of document. The model may be trained to recognize data fields associated with a particular document type and process the data associated with the data fields in particular documents.

Processing the first document may include recognizing text, data fields, or other values associated with the first document. For example, processing the first document may include converting the first document to a machine-readable format, if the first document is not already in a machine-readable format. Processing the first document may also include identifying one or more values that may correspond to one or more data fields associated with the first document. For example, if a first document is a receipt, then processing the first document may include identifying one or more prices associated with the purchased items listed on the receipt and identifying a total price of all items listed on the receipt.

Step 715 of process 700 may include causing a display, via a user interface, of the one or more values in connection with the plurality of data fields. The one or more values may be displayed on a graphical user interface of a computing device, such as computing device 130, as disclosed herein with respect to FIG. 1. The one or more values may be populated with the plurality of data fields on the graphical user interface. In some embodiments, the graphical user interface may display the data fields and the associated values. In other embodiments, the graphical user interface may display the data fields and the associated values and the first document.

Step 720 of process 700 may include receiving a user input. The user input may be received through I/O devices 230 associated with computing device 130, as disclosed herein with respect to FIG. 1. In some embodiments, the user input may be received from a user associated with an enterprise organization, such as user 115. In some embodiments, as disclosed herein, user 115 may comprise a low-code developer who may have limited or no data science, machine learning, or coding knowledge. The user input received in step 720 of process 700 may be received through a low-code platform, such as low-code platform 315. Low-code platform 315 may allow user 115 to provide basic inputs that may be used to update and train the model, without requiring user 115 to provide inputs directly related to the machine learning algorithm or code. For example, in some embodiments, the user input may include one or more of a confirmation of the one or more values, a correction of the one or more values, a correction of the one or more of the plurality of data fields, or an addition of a new value for a data field of the plurality of data fields. User 115 may review the first document and compare the data fields and values found in the first document to the data fields and values displayed on the graphical user interface. If the data fields and values on the graphical user interface match the first document, then user 115 may confirm the one or more values associated with the one or more data fields displayed on the graphical user interface. If the data fields or the values on the graphical user interface do not match the first document, then user 115 may correct the one or more values and/or the one or more data fields. In other embodiments, if a data field displayed on the graphical user interface does not include an associated value, then user 115 may enter a new value for the data field based on the first document.

In some embodiments, output data for the first document may be generated based on the user input. In some embodiments, the output data may include values associated with one or more data fields identified by the model that are then confirmed by the user. For example, the output data may include data values and associated data fields that have been confirmed by the user to match the first document. The output data may be stored in a database, such as database 140 as disclosed herein with respect to FIG. 1. The output data may be used as sample data for training the machine learning model. For example, the model may be associated with the database that stores user-confirmed output data for a plurality of documents processed based on the model. The database may include the confirmed output data associated with the first document and confirmed output data associated with a plurality of other documents that may be of the same or different type as the first document. The confirmed output data stored in the database may be used as sample data for training the machine learning model.

Step 725 of process 700 may include updating the model based on the user input. Updating the model may include training the model based on the user input. For example, the first document and the corrected data fields and plurality of values may be used as sample data to train the machine learning model. Using the first document and the user input as sample data may allow the machine learning model to more accurately recognize the data fields and values associated with the first document in future cases. Further, updating the machine learning model may occur automatically after receiving the user input. For example, updating the machine learning model may occur without data preparation or data customization from user 115. Accordingly, the machine learning model may be automatically updated based on the input received from user 115, who may not have machine learning or coding expertise.

In some embodiments, updating the model based on the user input may include using a pretrained model with an overlaid mapping layer. For example, a pretrained model may comprise a machine learning model that may be trained for a related task, but may not be trained for the specific business use case that user 115 is configuring. The pretrained model may include a mapping layer, which may include the last layer or the last several layers of the pretrained model where a final classification may occur. The mapping layer of the pretrained model may be retrained using a small dataset to allow the pretrained model to be used in a more customized application based on the specific business use cases of user 115. In addition to requiring a smaller dataset for training, retraining the mapping layer of the pretrained model may further reduce the time and computing power required to train a customized machine learning model. This may improve computing efficiency and reduce the amount of computing resources required to train a customized machine learning model for specific business use cases. For example, the mapping layer of the pretrained model may be retrained based on the user input received in step 720 of process 700 so that the pretrained model may be used for the specific business application being configured by user 115. The overlaid mapping layer may be refined and trained over time based on the input received from user 115 in step 720 of process 700. The overlaid mapping layer may be refined automatically and in real time during operation of the model.

In other embodiments, updating the model based on the user input may include using trainable machine learning models configured by developers in advance of use by user 115. Developers may configure a machine learning model that may be customized for a specific business use in advance of use by user 115. The machine learning model may be deployed to production and may be retrained during production. For example, the machine learning model may be deployed for use by user 115. The machine learning model may be updated and trained based on the user input received in step 720 of process 700. For example, the first document identified in step 705 of process 700 and the user input received in step 720 of process 700 may be used as sample training data to automatically update the model during production.

In some embodiments, names of the plurality of data fields and data types of the plurality of data fields may be received. In some embodiments, the names of the plurality of data fields and data types of the plurality of data fields may be received from user 115. For example, process 700 may include causing a display of a user interface configured to allow a user to enter the names of the plurality of data fields and the data types of the plurality of data fields, wherein the names and the data types are customized for a particular type of document associated with the user. For example, user 115 may view a graphical user interface and input the names and data types of the data fields by using I/O devices 230 associated with computing device 130. User 115 may review and process a particular type of document that may have the same data field names and types. Accordingly, user 115 may enter the names of the data fields and the data types associated with the data fields for each particular type of document. Names of the plurality of data fields may include identifiers that label the plurality of data fields. Data types may include an identifier of the type of data that may be associated with a particular data field (e.g., numerical data, text data, etc.). The machine learning model may be updated and trained based on the names and the data types. For example, the machine learning model may be trained to recognize certain data types in documents that may correspond to a particular data field. The machine learning model may be further trained to recognize the names of the data fields in the documents.

Step 730 of process 700 may include identifying a second document. In some embodiments, the second document may be received as an attachment to an email. In other embodiments, the second document may be submitted through a web application, an online portal, an instant messaging service, or by any other means of electronically transmitting a document. In some embodiments, the second document may be a same document type as the first document. In other embodiments, the second document may be a different document type than the first document. In some embodiments, the second document may include an invoice, a receipt, a form, a contract, an agreement, a bank statement, a financial report, or any other form of document.

Step 735 of process 700 may include processing, using the updated model, the second document to identify one or more second values, in the second document, corresponding to one or more of the plurality of data fields. Step 735 of process 700 may correspond to step 710 of process 700, as disclosed herein. For example, processing the second document may include recognizing text, data fields, or other values associated with the second document. Processing the second document may include converting the second document to a machine-readable format, if the second document is not already in a machine-readable format. Processing the second document may also include identifying and extracting one or more values that may correspond to one or more data fields associated with the second document. For example, if a second document is a receipt, then processing the second document may include identifying one or more prices associated with the purchased items listed on the receipt and identifying a total price of all items listed on the receipt. The updated machine learning model may be able to more accurately identify and extract values and data fields from the second document based on the training completed in step 725 of process 700.

FIG. 8 depicts a flowchart of a process 800 for training a customizable machine learning model to effectively process documents. Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

Step 805 of process 800 may include identifying the names of a plurality of data fields associated with one or more types of documents. A plurality of document types may be analyzed in process 800, and each plurality of document type may have specific data fields. For example, document types may include invoices, receipts, forms, contracts, agreements, bank statements, financial reports, or any other document type. Data fields may include a piece of information within the document type that may contain data. For example, if the document type is an invoice, the data fields may include customer name, invoice number, vendor contact information, customer contact information, payment terms, date, itemized list of goods or services, subtotal, and other data fields. Each data field in a document may have a corresponding name that may label and identify data fields within a document. In some embodiments, the names of data fields may be assigned by an enterprise organization. In other embodiments, the names of data fields may be automatically assigned using a machine learning model. Identifying the names of the data fields may include identifying the data fields that are included in the type of document.

Step 810 of process 800 may include identifying data types of the plurality of data fields. In some embodiments, a data type may be a type of value that a variable may accept. For example, a data type may include an integer, a character, a date, a string, a Boolean, a decimal, or any other data type. In some embodiments, data fields may be restricted to receiving specific data types. The data types may be identified based on the data fields identified in step 805 of process 800. For example, each data field may include a corresponding data type or types.

Step 815 of process 800 may include configuring, based on the names and the data types, a model for identifying values corresponding to the plurality of data fields in documents of the one or more types. In some embodiments, the model may comprise a pre-trained machine learning model. For example, the model may correspond to machine learning model 160, as disclosed herein with respect to FIG. 1. The model may be customized to process a particular type of document for an enterprise organization. For example, the model may be customized to process one or more document types, such as an invoice, a receipt, a form, a contract, an agreement, a bank statement, a financial report, or any other form of document. The model may be trained to recognize data fields associated with a particular document type and process the data associated with the data fields in particular documents. In some embodiments, configuring the model may include training the machine-learning model to recognize and extract data based on the names and data types of the data fields associated with a particular document type.

Step 820 of process 800 may include receiving a document of the one or more type. In some embodiments, the first document may be received as an attachment to an email. In other embodiments, the first document may be submitted through a web application, an online portion, an instant messaging service, or by any other means of electronically transmitting a document. In some embodiments, the document may include an invoice, a receipt, a form, a contract, an agreement, a bank statement, a financial report, or any other form of document.

Step 825 of process 800 may include processing, using the model, the document to identify one or more values in the document corresponding to one or more of the plurality of data fields. Processing the document may include recognizing text, data fields, or other values associated with the document. For example, processing the document may include converting the document to a machine-readable format, if the document is not already in a machine-readable format. Processing the document may also include identifying one or more values that may correspond to one or more data fields associated with the document. For example, if a document is a receipt, then processing the document may include identifying one or more prices associated with the purchased items listed on the receipt and identifying a total price of all items listed on the receipt.

Step 830 of process 800 may include causing a display, via a user interface, of the one or more values in connection with the plurality of data fields. The one or more values may be displayed on a graphical user interface of a computing device, such as computing device 130, as disclosed herein with respect to FIG. 1. The one or more values may be populated with the plurality of data fields on the graphical user interface. In some embodiments, the graphical user interface may display the data fields and the associated values. In other embodiments, the graphical user interface may display the data fields and the associated values in addition to the document.

Step 835 of process 800 may include receiving a user input. The user input may be received through I/O devices 230 associated with computing device 130, as disclosed herein with respect to FIG. 1. In some embodiments, the user input may be received from a user associated with an enterprise organization, such as user 115. In some embodiments, the user input may include one or more of a confirmation of the one or more values, a correction of the one or more values, a correction of the one or more of the plurality of data fields, or an addition of a new value for a data field of the plurality of data fields. User 115 may review the first document and compare the data fields and values found in the first document to the data fields and values displayed on the graphical user interface. If the data fields and values on the graphical user interface match the first document, then user 115 may confirm the one or more values associated with the one or more data fields displayed on the graphical user interface. If the data fields or the values on the graphical user interface do not match the first document, then user 115 may correct the one or more values and/or the one or more data fields. In other embodiments, if a data field displayed on the graphical user interface does not include an associated value, then user 115 may enter a new value for the data field based on the first document.

In some embodiments, output data for the first document may be generated based on the user input. In some embodiments, the output data may include values associated with one or more data fields identified by the model that are then confirmed by the user. For example, the output data may include data values and associated data fields that have been confirmed by the user to match the first document. The output data may be stored in a database, such as database 140 as disclosed herein with respect to FIG. 1. The output data may be used as sample data for training the machine learning model. For example, the model may be associated with the database that stores user-confirmed output data for a plurality of documents processed based on the model. The database may include the confirmed output data associated with the document and confirmed output data associated with a plurality of other documents that may be of the same or different type as the document. The confirmed output data stored in the database may be used as sample data for training the machine learning model.

Step 840 of process 800 may include updating the model based on the user input. Updating the model may include training the model based on the user input. For example, the document and the corrected data fields and plurality of values may be used as sample data to train the machine learning model. Using the document and the user input as sample data may allow the machine learning model to more accurately recognize the data fields and values associated with documents of the same or similar document types in future cases.

In some embodiments, names of the plurality of data fields and data types of the plurality of data fields may be received. In some embodiments, the names of the plurality of data fields and data types of the plurality of data fields may be received from user 115. For example, process 800 may include causing a display of a user interface configured to allow a user to enter the names of the plurality of data fields and the data types of the plurality of data fields, wherein the names and the data types are customized for a particular type of document associated with the user. For example, user 115 may view a graphical user interface and input the names and data types of the data fields by using I/O devices 230 associated with computing device 130. User 115 may review a particular type of document that may have the same data field names and types. Accordingly, user may enter the names of the data fields and the data types associated with the data fields for each particular type of document. Names of the plurality of data fields may include identifiers that label the plurality of data fields. Data types may include an identifier of the type of data that may be associated with a particular data field (e.g., numerical data, text data, etc.). The machine learning model may be updated and trained based on the names and the data types. For example, the machine learning model may be trained to recognize certain data types in documents that may correspond to a particular data field. The machine learning model may be further trained to recognize the names of the data fields in the documents.

In some embodiments, the names of the plurality of data fields may comprise a first identifier of a first data field. In such embodiments, updating the model based on the user input may include determining a second identifier for the first data field based on the user input. In some embodiments, a data field may be identified by multiple identifiers. For example, different data fields may be used differently in various systems associated with an enterprise organization. The user input may include labeling a second identifier for the first data field. The machine learning model may be updated and trained to identify the first data field based on both the first identifier and the second identifier. In some embodiments, the first identifier and the second identifier may be used as a key for identifying a value in a key-value pair in a document. A key-value pair may include a data structure in which two or more pieces of information are linked together. The key may act as a unique identifier and the value may include data associated with the key.

In some embodiments, process 800 may further include receiving a second document and processing, using the updated model, the second document to identify one or more second values corresponding to one or more of the plurality of data fields. The second document may be of the same document type as the first document. Accordingly, the machine learning model may be able to more accurately identify data fields and associated values in the second document based on the training received based on the first document. The machine learning model may be used to identify additional values that may correspond to a plurality of data fields in the second document.

In some embodiments, process 800 may further include receiving an indication of a plurality of sections of a document of the one or more types. A plurality of sections of a document may be identified and labeled by a user. For example, user 115 may identify sections of a document type using I/O devices 230 of computing device 130. The indication may indicate that a first subset of the plurality of data fields are included in a first section of the plurality of sections and that a second subset of the plurality of data fields are included in a second section of the plurality of sections. For example, various subsets of data fields may be included in each of the sections of the document type. The separation of the sections of the document may indicate which subset of data fields correspond to each section of the document type. In some embodiments, the machine learning model may be configured based on the plurality of sections. For example, in some embodiments, the machine learning model may be trained to recognize and extract data based on the plurality of sections. In some embodiments, the machine learning model may be trained to recognize and extract data from some, but not all, sections of a document type. In other embodiments, the machine learning model may be trained to process extracted data from each section of the document type differently. For example, the machine learning model may be trained to display data values extracted from a first section of the document type on a first graphical user interface and to display data values extracted from a second section of the document type on a second graphical user interface.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A non-transitory computer-readable medium including instructions that, when executed by at least one processor, cause the at least one processor to perform operations for training a customizable machine-learning model to effectively process documents, the operations comprising:
identifying a first document;
processing, using a model, the first document to identify one or more values, in the first document, corresponding to one or more of a plurality of data fields associated with the first document;
causing a display, via a user interface, of the one or more values in connection with the plurality of data fields;
receiving user input, wherein the user input indicates one or more of: a confirmation of the one or more values, a correction of the one or more values, a correction of the one or more of the plurality of data fields, or an addition of a new value for a data field of the plurality of data fields;
updating the model based on the user input;
identifying a second document; and
processing, using the updated model, the second document to identify one or more second values, in the second document, corresponding to one or more of the plurality of data fields.

2. The non-transitory computer-readable medium of claim 1, wherein the model comprises a pre-trained machine-learning model with an overlaid mapping layer.

3. The non-transitory computer-readable medium of claim 1, wherein the model comprises a trainable machine-learning model configured to be retrained in production.

4. The non-transitory computer-readable medium of claim 1, wherein updating the model based on the user input comprises:
training the machine-learning model based on the user input.

5. The non-transitory computer-readable medium of claim 1, wherein the operations further comprise:
based on the user input, generating output data for the first document, wherein the output data includes values, determined by the model to map to one or more of the plurality of data fields, that are confirmed by a user.

6. The non-transitory computer-readable medium of claim 1, wherein the operations further comprise associating the model with a database for storing user-confirmed output data for a plurality of documents processed based on the model.

7. The non-transitory computer-readable medium of claim 1, wherein the first document and the second document are of a same type or of a different type.

8. The non-transitory computer-readable medium of claim 1, wherein the model is customized to process a particular type of document for an enterprise organization.

9. The non-transitory computer-readable medium of claim 1, wherein the operations further comprise:
receiving names of the plurality of data fields and data types of the plurality of data fields; and
training the model based on the names and the data types.

10. The non-transitory computer-readable medium of claim 1, wherein the operations further comprise causing a display of a user interface configured to allow a user to enter the names of the plurality of data fields and the data types of the plurality of data fields, wherein the names and the data types are customized for a particular type of document associated with the user.

11. A non-transitory computer-readable medium including instructions that, when executed by at least one processor, cause the at least one processor to perform operations for training a customizable machine-learning model to effectively process documents, the operations comprising:
identifying names of a plurality of data fields associated with one or more types of documents;
identifying data types of the plurality of data fields;
configuring, based on the names and the data types, a model for identifying values corresponding to the plurality of data fields in documents of the one or more types;
receiving a document of the one or more types;
processing, using the model, the document to identify one or more values, in the document, corresponding to one or more of the plurality of data fields;
causing a display, via a user interface, of the one or more values in connection with the plurality of data fields;
receiving user input, wherein the user input indicates one or more of: a confirmation of the one or more values, a correction of the one or more values, a correction of the one or more of the plurality of data fields, or an addition of a new value for a data field of the plurality of data fields; and
updating the model based on the user input.

12. The non-transitory computer-readable medium of claim 11, wherein the model comprises a machine-learning model.

13. The non-transitory computer-readable medium of claim 11, wherein configuring the model based on the names and the data types comprises training the machine-learning model based on the names and the data types, and wherein updating the model based on the user input comprises training the machine-learning model based on the user input.

14. The non-transitory computer-readable medium of claim 11, wherein the operations further comprise based on the user input, generating output data for the document, wherein the output data includes values, determined by the model to map to one or more of the plurality of data fields, that are confirmed by a user.

15. The non-transitory computer-readable medium of claim 11, wherein the document is a first document, and wherein the operations further comprise:
receiving a second document of the one or more types, wherein the second document is of the same type as the first document; and
processing, using the updated model, the second document to identify one or more second values corresponding to one or more of the plurality of data fields.

16. The non-transitory computer-readable medium of claim 11, wherein the operations further comprise causing a display of a user interface configured to allow a user to enter the names of the plurality of data fields and the data types of the plurality of data fields, wherein the names and the data types are customized for a particular type of document associated with the user.

17. The non-transitory computer-readable medium of claim 11, wherein the operations further comprise receiving an indication of a plurality of sections of a document of the one or more types, wherein the indication indicates that a first subset of the plurality of data fields are included in a first section of the plurality of sections and that a second subset of the plurality of data fields are included in a second section of the plurality of sections.

18. The non-transitory computer-readable medium of claim 17, wherein the operations further comprise configuring the model based on the indication of the plurality of sections.

19. The non-transitory computer-readable medium of claim 11, wherein the names of the plurality of data fields comprise a first identifier for a first data field of the plurality of data fields, and wherein updating the model based on the user input comprises determining, based on the user input, a second identifier for the first data field.

20. The non-transitory computer-readable medium of claim 19, wherein each of the first identifier and the second identifier is used as a key for identifying a value in a key-value pair in a document of the one or more types.
